(19) United States
(12) Patent Application Publication
(10) Pub. No.: US 2010/0186339 A1
(43) Pub. Date: Jul. 29, 2010

(54) HOLLOW WINDOW OR DOOR SECTION

(75) Inventor: Leszek Gierszewski, Skupsk (PL)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Drutex S.A.

(21) Appl. No.: 12/452,057

(22) PCT Filed: Jun. 12, 2008
(86) PCT No.: PCT/EP2008/057399

§ 371 Date: Mar. 24, 2010

(30) Foreign Application Priority Data
Jun. 15, 2007 (AT) A 934/2007

(51) Int. Cl. E06B 3/16

(52) U.S. Cl. 52/656.2

(57) ABSTRACT

A hollow window or door section includes at least one mounting groove for accommodating a covering rail fitting, with the mounting groove having lowered shoulders in the starting region of the groove flanks in order to accommodate a covering rail that can be fixedly connected to the hollow window or door section. In order to prevent the wall thicknesses from being reduced as a result of mounting, the mounting groove has a substantially dovetail-shaped section from a cross-sectional view and the groove flanks enclose an angle of between 45° and 85° with the groove bottom of the mounting groove.

The invention relates to a hollow window or door section, comprising at least one mounting groove for accommodating a covering rail fitting, with the mounting groove having lowered shoulders in the starting region of the groove flanks in order to accommodate a covering rail that can be fixedly connected to the hollow window or door section.

Mounting grooves are used for accommodating covering rail fittings which consist of a covering rail and a driving rod which is displaceable in the longitudinal direction for actuating the locking means of the wing of a door or window. As disclosed in the specifications DE 101 03 468 A1 or DE 73 29 840 U, it is known to equip these fastening grooves with a rectangular section.

The actuation of the driving rod occurs for example via a pivoted lever, with the direction of actuation acting on the driving rod by means of an actuating gear. The gear is also arranged at least partly in the mounting groove. A lateral machining of the groove flanks is necessary for inserting the gear in the mounting groove. This leads to the disadvantage in hollow window or door sections with mounting grooves that are rectangular in their cross section that the machining of the groove flanks leads to a weakening of the wall thickness of the hollow window or door section in the region of the mounting rail. This may subsequently lead to cracks and fractures.

DE 24 52 087 A1 describes a glass holding strip for fixing the glazing in the frames of windows or doors which are formed from the sections, which strip hooks with a holding cam into a groove, undercut or the like formed by a projection on the frame section. The fame section comprises a groove for inserting an elastic seal in the region of the projection of a stop which is used for inserting an elastic seal.

This groove, which cannot be designated as dovetailed in any way, is not suitable as a mounting rail for accommodating a covering rail fitting.

DE 31 01 393 A1 discloses a casement for a door or window which is equipped with a covering rail fitting which comprises an accommodating groove for a locking rod which is covered by a covering rail, which locking rod is held in a displaceable manner in its longitudinal axis between the covering rail and several U-shaped holders made of a high-strength material.

The mounting rail disclosed in DE 31 01 393 A1 does not have any dovetail-shaped section, as is defined in the characterizing part of the new claim 1 of the present application.

EP 0 892 138 A2 shows a covering rail fitting for a door or a window, comprising a covering rail which covers an accommodating groove for the driving rod, with the driving rod which is displaceable in its longitudinal axis being held on the covering rail. The accommodating groove has a substantially rectangular cross section.

It is the object of the invention to avoid such disadvantages and to improve a hollow window or door section of the kind mentioned above in such a way that any weakening of the material strength caused by the mounting is avoided.

This is achieved in accordance with the invention in such a way that the mounting groove has a substantially dovetail-shaped section from a cross-sectional view and the groove flanks enclose an angle of between 45° and 85°, preferably between 60° and 80°, more preferably approximately 70°, with the bottom of the mounting groove.

The dovetail shape of the mounting groove comes with the advantage that during the insertion of the gear it is only necessary to remove material in the region of the shoulders and no longer along the entire groove flanks. Relevant weakening of the wall thickness of the hollow window or door section is thus effectively prevented.

In order to enable a secure seat and correct mounting of the covering rail fitting it is especially advantageous when the covering rail comprises at least one side surface which is arranged approximately normal to the bottom of the groove, with preferably the covering rail having two mutually facing parallel side surfaces.

The invention is now explained below in closer detail by reference to the drawings, wherein:

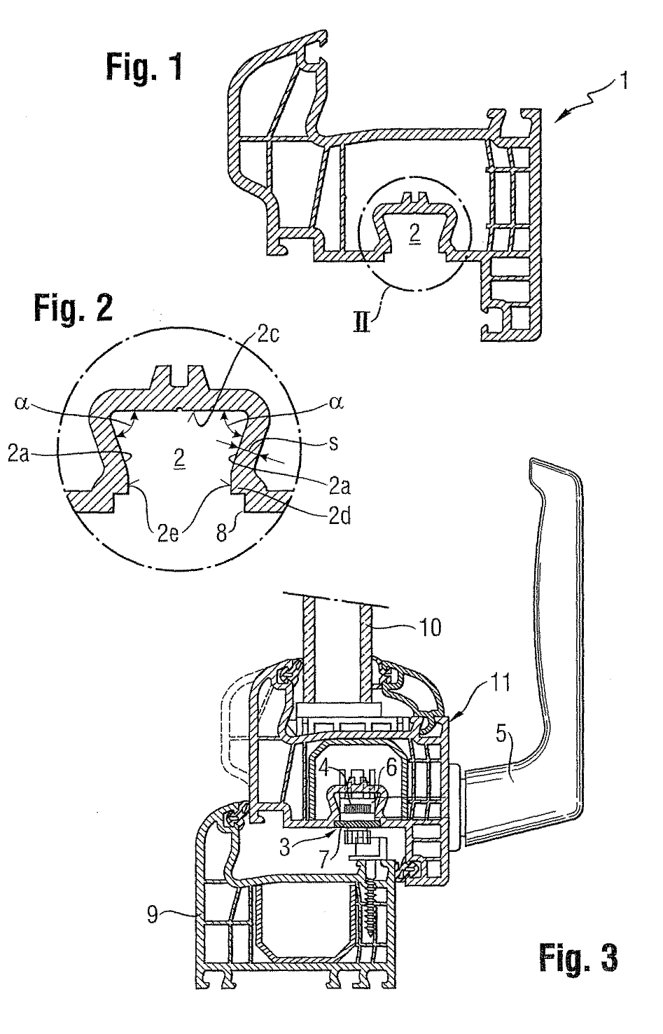

FIG. 1 shows a hollow window section in a cross-sectional view;

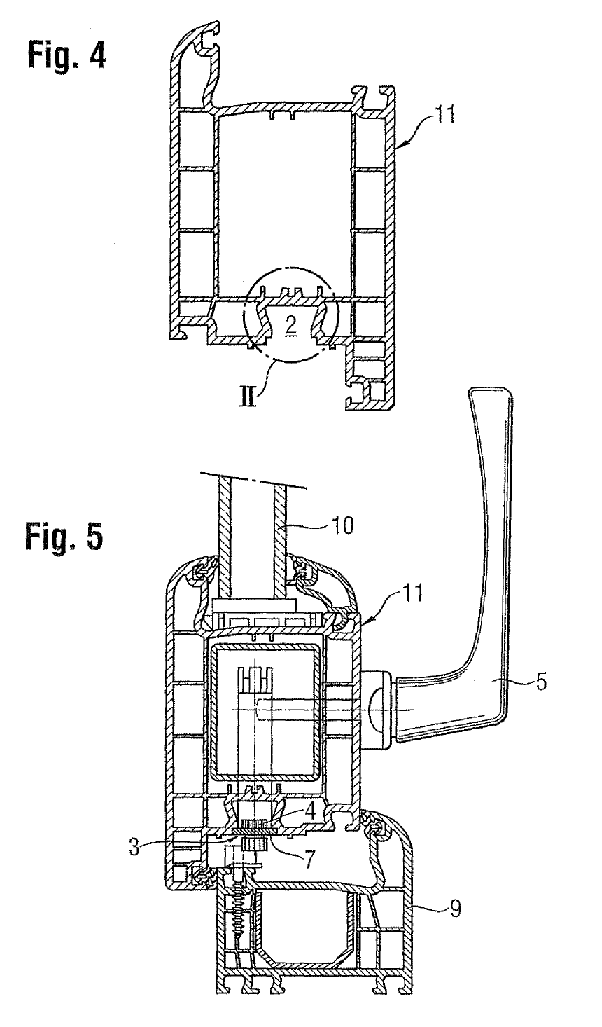

FIG. 2 shows the detail II of FIGS. 1 and 4;

FIG. 3 shows the hollow window section plus actuating mechanism;

FIG. 4 shows a hollow door section in a cross-sectional view, and

FIG. 5 shows the hollow door section plus actuating mechanism.

The hollow window section 1 as shown in the FIGS. 1 to 3 and the hollow door section 11 as shown in FIGS. 4 and 5 comprise a mounting rail 2 for accommodating a covering rail fitting 3 and an actuating gear 4 which is actuated by an actuating lever 5. The actuating gear 4 acts upon a driving rod 6 which is arranged in a displaceable manner in the actuating groove 2. The covering rail 7 is designated with reference numeral 7. Reference numeral 9 designates a window cross or door case and reference numeral 10 designates the glazing.

The mounting groove 2 has a dove-tail shaped section in the cross section, as is shown in detail in FIG. 2. The two groove flanks 2a, 2b each open an angle α of approximately 60° to 80°, e.g. 70°, with the groove bottom 2c. In the starting region 8 of the mounting groove 2, a lowered shoulder 2d is arranged for accommodating the covering rail 7. In the region of the shoulder 2d, the mounting groove 2 comprises a parallel side surface 2e which is arranged approximately normal to the groove bottom 2c.

Only the enlarged region of the shoulders 2d is milled off for inserting the actuating gear 4. This comes with the advantage that the wall thickness s of the remaining mounting groove 2 need not be reduced, so that a substantial weakening of the material of window section 1 can be effectively prevented.

1-3. (canceled)

4. A hollow window or door section, comprising at least one mounting groove for accommodating a covering rail fitting, with the mounting groove having lowered shoulders in a starting region of groove flanks in order to accommodate a covering rail that can be fixedly connected to the hollow window or door section, wherein the mounting groove has a substantially dovetail-shaped section from a cross-sectional view and the groove flanks enclose an angle of between 45° and 85° with a groove bottom of the mounting groove.

5. The hollow window or door section according to claim 4, wherein the groove flanks enclose an angle of between 60° and 80° with a groove bottom of the mounting groove.

6. The hollow window or door section according to claim 4, wherein the groove flanks enclose an angle of approximately 70° with a groove bottom of the mounting groove.

7. The hollow window or door section according to claim 4, wherein the mounting groove comprises at least one side surface which is arranged approximately normal to the groove bottom in the region of the shoulders.

8. The hollow window or door section according to claim 4, wherein the mounting groove comprises two parallel side surfaces which face one another.
